(19) United States
(12) Patent Application Publication
(10) Pub. No.: US 2026/0067461 A1
(43) Pub. Date: Mar. 5, 2026

(54) IMAGE PROCESSING METHOD AND ELECTRONIC DEVICE PERFORMING IMAGE PROCESSING

(71) Applicant: SAMSUNG ELECTRONICS CO., LTD., Suwon-si (KR)

(72) Inventors: Jeongwon KIM, Suwon-si (KR); SEOK KANG, Suwon-si (KR); SEUNGEON KIM, Suwon-si (KR); Jun Hyuk KIM, Suwon-si (KR); WONSEOP SONG, Suwon-si (KR); WONHEE LEE, Suwon-si (KR); Woosuk CHOI, Suwon-si (KR); YOUNG HUN SUNG, Suwon-si (KR); DOKWAN OH, Suwon-si (KR)

(73) Assignee: SAMSUNG ELECTRONICS CO., LTD., Suwon-si (KR)

(21) Appl. No.: 19/013,512

(22) Filed: Jan. 8, 2025

(30) Foreign Application Priority Data
Sep. 4, 2024 (KR) 10-2024-0120149

(51) Int. Cl. H04N 19/13; H04N 19/119; H04N 19/124; H04N 19/176; H04N 19/189; H04N 19/436

(52) U.S. Cl. CPC H04N 19/13; H04N 19/119; H04N 19/124; H04N 19/176; H04N 19/189; H04N 19/436

(57) ABSTRACT

An image processing method using a neural network includes receiving input image data, generating a first latent vector corresponding to the input image data by inputting the input image data to the neural network and encoding the input image data, and generating a second latent vector based on the first latent vector, where a range of the first latent vector is adjusted based on a preset target compression ratio.

### CROSS-REFERENCE TO RELATED APPLICATIONS

This application is based on and claims priority to Korean Patent Application No. 10-2024-0120149, filed on Sep. 4, 2024, in the Korean Intellectual Property Office, the disclosure of which is incorporated by reference herein in its entirety.

### BACKGROUND

### 1. Field

The disclosure relates to an image processing method and an electronic device performing image processing.

### 2. Description of Related Art

Technologies using artificial neural networks (ANN) have advanced rapidly, facilitating the fast growth of ANN-based video compression (or encoding) and restoration (or decoding) techniques. A neural codec may operate using a neural network. The neural codec may employ entropy coding to increase data compression efficiency and reduce transmission bandwidth. Further, video data and/or image data have become higher in resolution, and there is thus a growing need for traffic reduction.

### SUMMARY

Additional aspects will be set forth in part in the description which follows and, in part, will be apparent from the description, or may be learned by practice of the presented embodiments of the disclosure.

According to an aspect of the disclosure, an image processing method using a neural network may include receiving input image data, generating a first latent vector corresponding to the input image data by inputting the input image data to the neural network and encoding the input image data, and generating a second latent vector based on the first latent vector, where a range of the first latent vector is adjusted based on a preset target compression ratio.

The generating of the second latent vector may include clipping the range of the first latent vector to a range corresponding to the preset target compression ratio,

The generating of the second latent vector may include quantizing the clipped first latent vector.

The method may include determining a first compression ratio corresponding to the second latent vector and adaptively determining whether to perform entropy coding on the second latent vector, based the first compression ratio.

The adaptively determining whether to perform the entropy coding may include, based on the first compression ratio of the second latent vector being greater than or equal to the preset target compression ratio, determining to bypass the entropy coding for the second latent vector, and based on the first compression ratio of the second latent vector being less than the preset target compression ratio, determining to perform the entropy coding on the second latent vector.

The adaptively determining whether to perform the entropy coding may include setting a value of a bypass flag corresponding to the second latent vector.

The setting of the value of the bypass flag may include based on determining to bypass the entropy coding for the second latent vector, setting the value of the bypass flag to a first value, and based on determining to perform the entropy coding on the second latent vector, setting the value of the bypass flag to a second value that is different from the first value.

The method may include generating a bitstream by performing entropy coding on the second latent vector, comparing a second compression ratio of the second latent vector that is entropy-coded to a third compression ratio, and outputting either the bitstream or the second latent vector, based on a result of the comparison.

The method may include learning a coding table corresponding to an entropy coder based on the range of the second latent vector that is adjusted based on the preset target compression ratio.

The outputting of either the bitstream or the second latent vector based on the result of the comparing may include based on the second compression ratio being greater than or equal to the third compression ratio, outputting the bitstream, and based on the second compression ratio being less than the third compression ratio, outputting the second latent vector.

The input image data may include an input image block, and the method may include dividing the input image block into sub-blocks.

The generating of the first latent vector may include generating first sub-latent vectors respectively corresponding to the sub-blocks by encoding the sub-blocks, the generating of the second latent vector may include generating second sub-latent vectors based on the first sub-latent vectors, and respective ranges of the first sub-latent vectors may be adjusted based on the preset target compression ratio.

The generating of the first sub-latent vectors may include inputting the sub-blocks to the neural network in parallel and encoding the sub-blocks.

The method may include determining whether to perform entropy coding on each of the second sub-latent vectors.

The determining whether to perform the entropy coding on each of the second sub-latent vectors may include determining a 1-2 compression ratio of each of the second sub-latent vectors, and adaptively determining whether to perform the entropy coding on each of the second sub-latent vectors, based on whether the 1-2 compression ratio of each of the second sub-latent vectors satisfies the preset target compression ratio.

According to an aspect of the disclosure, an image processing method using a neural network may include receiving incoming data including a first latent vector or a bitstream, the incoming data including a bypass flag, reading a value of the bypass flag, determining a restoration method for the first latent vector or the bitstream, based on the value of the bypass flag, and restoring the incoming data by decoding the first latent vector or the bitstream based on the determined restoration method.

The determining of the restoration method may include, based on the value of the bypass flag being a first value, determining the restoration method to be a first restoration method that restores the first latent vector without performing entropy decoding, and based on the value of the bypass flag being a second value, determining the restoration method to be a second restoration method that converts the bitstream into a second latent vector by performing entropy decoding.

The restoring of the incoming data based on the determined restoration method may include, based on the restoration method being determined to be the first restoration method, restoring the incoming data by inputting the first latent vector to the neural network and decoding the first latent vector.

The restoring of the incoming data based on the determined restoration method may include, based on the restoration method being determined to be the second restoration method, converting the bitstream into the second latent vector using a set coding table, and restoring the incoming data by inputting the second latent vector to the neural network and decoding the second latent vector.

According to an aspect of the disclosure, electronic device configured to perform image processing using a neural network may include memory storing instructions, and a processor, where the instructions, when executed by the processor, may cause the electronic device to generate a first latent vector corresponding to input image data by inputting the input image data to the neural network and encoding the input image data, generate a second latent vector that is quantized by adjusting a range of the first latent vector based on a preset target compression ratio, receive incoming data comprising a bitstream or the second latent vector, read a value of a bypass flag of the incoming data, and restore, by the neural network, the incoming data by decoding the second latent vector or the bitstream based on a restoration method, where the restoration method is determined based on the value of the bypass flag.

According to an aspect of the disclosure, electronic device configured to perform image processing using a neural network may include memory storing instructions, and a processor, where the instructions, when executed by the processor, may cause the electronic device to receive input image data, generate a first latent vector corresponding to the input image data by inputting the input image data to the neural network and encoding the input image data, and generate a second latent vector based on the first latent vector, where a range of the first latent vector is adjusted based on a preset target compression ratio.

The instructions, when executed by the processor, may further cause the electronic device to generate a bitstream by performing entropy coding on the second latent vector, compare a second compression ratio of the second latent vector that is entropy-coded to a third compression ratio, and output either the bitstream or the second latent vector, based on a result of the comparison.

The instructions, when executed by the processor, may further cause the electronic device to, based on the second compression ratio being greater than or equal to the third compression ratio, output the bitstream, and based on the second compression ratio being less than the third compression ratio, output the second latent vector.

The instructions, when executed by the processor, may further cause the electronic device to receive incoming data comprising the second latent vector or a bitstream, and a bypass flag, determine a restoration method for the second latent vector or the bitstream based on a value of the bypass flag, and restore the incoming data by decoding the second latent vector or the bitstream based on the determined restoration method.

The instructions, when executed by the processor, may cause the electronic device to determine the restoration method by determining the restoration method to be a first restoration method that restores the second latent vector without performing entropy decoding based on the value of the bypass flag being a first value, and determining the restoration method to be a second restoration method that converts the bitstream into a third latent vector by performing entropy decoding based on the value of the bypass flag being a second value.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating an electronic device performing an image processing method according to one or more embodiments;

FIGS. 2 through 5 are diagrams illustrating example structures and operations of an electronic device according to one or more embodiments;

FIG. 6 is a flowchart illustrating an image processing method of an electronic device performing encoding according to one or more embodiments;

FIG. 7 is a flowchart illustrating an image processing method of an electronic device performing encoding according to one or more embodiments;

FIG. 8 is a flowchart illustrating a method performed by an electronic device to adaptively determine whether to perform entropy coding on a latent vector according to one or more embodiments;

FIG. 9 is a flowchart illustrating an image processing method of an electronic device performing encoding according to one or more embodiments;

FIG. 10 is a flowchart illustrating an image processing method of an electronic device performing encoding according to one or more embodiments;

FIG. 11 is a flowchart illustrating an image processing method of an electronic device performing decoding according to one or more embodiments;

FIG. 12 is a flowchart illustrating a method performed by an electronic device performing decoding to determine a restoration method for incoming data according to one or more embodiments;

FIG. 13 is a flowchart illustrating a method of restoring incoming data based on a determined restoration method according to one or more embodiments;

FIG. 14 is a diagram illustrating an image processing system according to one or more embodiments;

FIG. 15 is a block diagram illustrating an electronic device performing encoding according to one or more embodiments;

FIG. 16 is a block diagram illustrating an electronic device performing decoding according to one or more embodiments; and

FIG. 17 is a block diagram illustrating an electronic device performing encoding and decoding according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, example embodiments will be described in detail with reference to the accompanying drawings. The embodiments described below are merely exemplary, and various modifications are possible from these embodiments. In the following drawings, the same reference numerals refer to the same components, and the size of each component in the drawings may be exaggerated for clarity and convenience of description.

In the following description, when a component is referred to as being “above” or “on” another component, it may be directly on an upper, lower, left, or right side of the other component while making contact with the other component or may be above an upper, lower, left, or right side of the other component without making contact with the other component.

Terms such as first, second, etc. may be used to describe various components, but are used only for the purpose of distinguishing one component from another component. These terms do not limit the difference in the material or structure of the components.

The terms of a singular form may include plural forms unless otherwise specified. In addition, when a certain part “includes” a certain component, it means that other components may be further included rather than excluding other components unless otherwise stated.

In addition, terms such as “unit” and “module” described in the specification may indicate a unit that processes at least one function or operation, and this may be implemented as hardware or software, or may be implemented as a combination of hardware and software.

The use of the term “the” and similar designating terms may correspond to both the singular and the plural.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

It is to be understood that, when a component is referred to as being “connected to” another component, the component can be directly connected or coupled to the other component or intervening components may be present.

It should be further understood that the terms “comprises,” “comprising,” “includes,” and/or “including,” when used in this specification, specify the presence of stated features, integers, steps, operations, elements, components, or a combination thereof, but do not preclude the presence or addition of one or more other features, integers, steps, operations, elements, components, and/or groups thereof.

The example embodiments described below may be expanded and applied to various devices, such as, for example, a content providing device configured to provide image or video content, an image broadcasting device, a terminal device configured to perform image transmission in a video call or video conference, or a mobile application processor (AP).

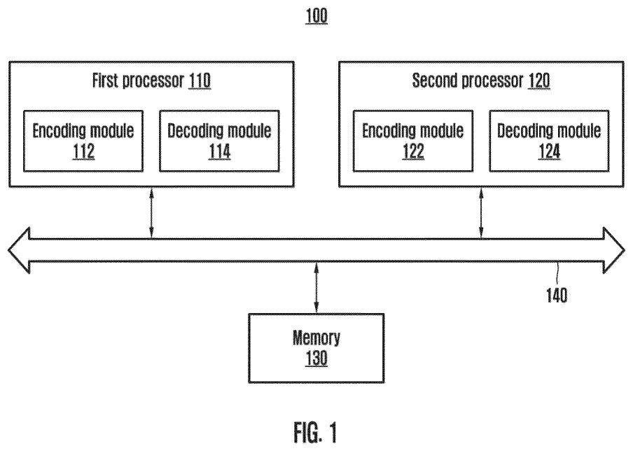

FIG. 1 is a diagram illustrating an electronic device performing an image processing method according to one or more embodiments. Referring to FIG. 1, according to one or more embodiments, an electronic device 100 may include a first processor 110, a second processor 120, and a memory 130. The components of the electronic device 100 may communicate with each other via a communication bus 140. The first processor 110, the second processor 120, the memory 130, and the communication bus 140 may be included in a system-on-chip (SoC). Some of the components may be omitted from or other components may be added to the electronic device 100. For example, the electronic device 100 may include the first processor 110 and the memory 130 but may not include the second processor 120.

The first processor 110 and the second processor 120 may perform various data (e.g., image) processing or computations. As at least part of the data processing or computations, the first processor 110 and the second processor 120 may store instructions and/or data received from other components in the memory 130, process the instructions and/or data stored in the memory 130, and store results of the processing in the memory 130. The first processor 110 and the second processor 120 may include, for example, a central processing unit (CPU), a graphics processing unit (GPU), a neural processing unit (NPU), a media processing unit (MPU), a data processing unit (DPU), a vision processing unit (VPU), a video processor, an image processor, s display processor, a microprocessor, a processor core, a multi-core processor, an application-specific integrated circuit (ASIC), a field-programmable gate array (FPGA), or any combination thereof.

The memory 130 may store various data used by the components (e.g., the first processor 110 and the second processor 120) of the electronic device 100. The data may include, for example, programs (e.g., applications), and input image data and/or output data associated therewith. The memory 130 may include a volatile memory and/or a non-volatile memory. The memory 130 may store instructions executable by the first processor 110 and/or the second processor 120. When the instructions stored in the memory 130 are executed by the first processor 110 and/or the second processor 120, the electronic device 100, by way of the first processor 110 and/or the second processor 120, may perform operations described herein.

The first processor 110 may include an encoding module 112 configured to encode data to generate encoded data and/or a decoding module 114 configured to decode encoded data generated by another component (e.g., the second processor 120) to generate restored (or reconstructed) data. The second processor 120 may include an encoding module 122 configured to encode data to generate encoded data and/or a decoding module 124 configured to decode encoded data generated by another component (e.g., the first processor 110) to generate restored (or reconstructed) data.

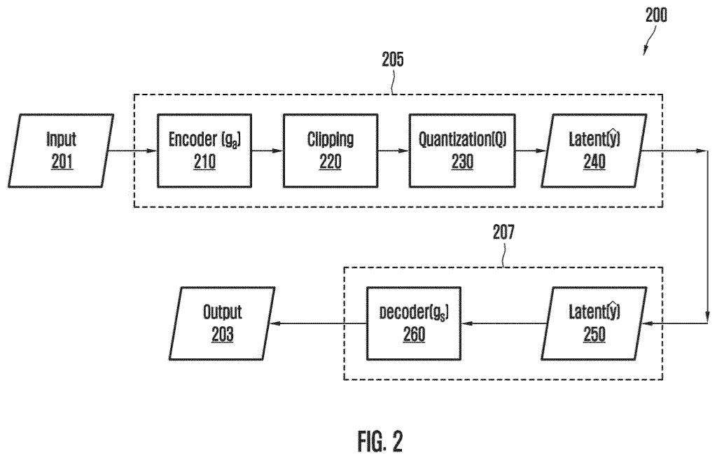

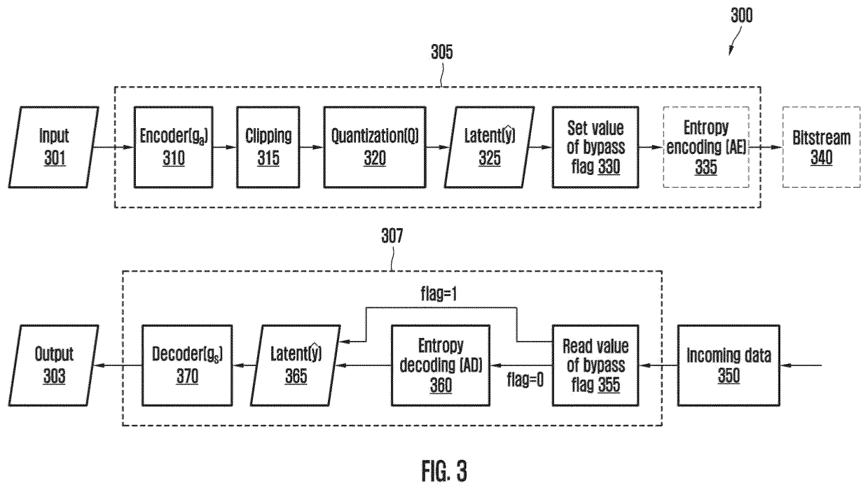

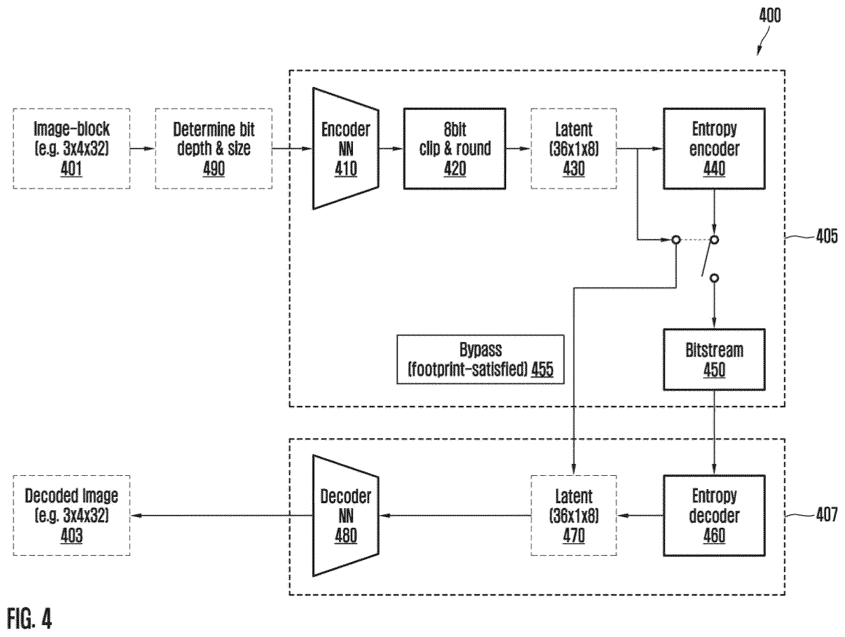

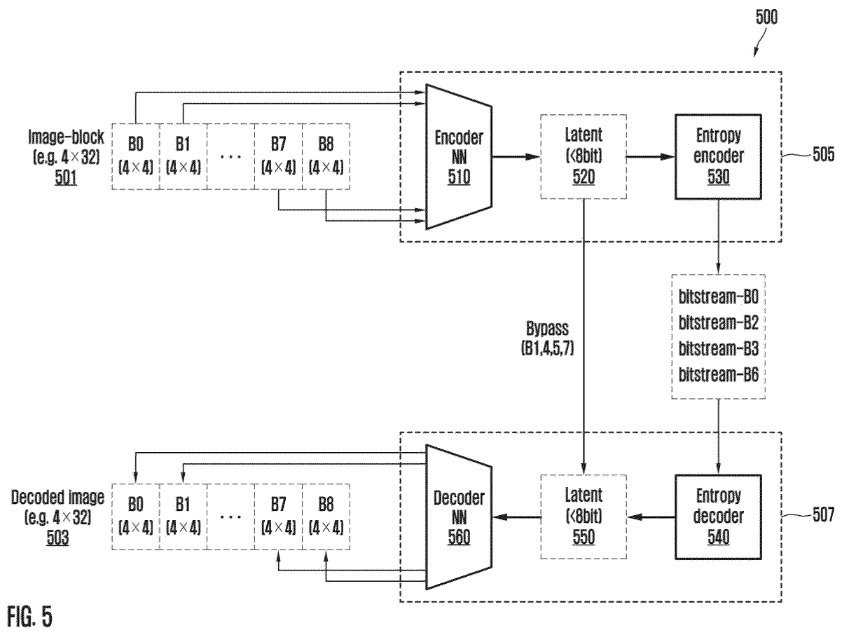

The encoding module 112 (e.g., an encoding module 205 of FIG. 2, an encoding module 305 of FIG. 3, an encoding module 405 of FIG. 4, and/or an encoding module 505 of FIG. 5) of the first processor 110 may encode input image data that is input the encoding module 112 and generate encoded data. The input image data may include, but is not necessarily limited to, at least one of image data, video data, audio data, or any combination thereof. For example, in a case where the input image data is an image, the input image data may include pixel values of pixels included in a local area (e.g., a block area) in the image. The encoding module 112 may include a neural network model-based encoder (e.g., an encoder 210 of FIG. 2, an encoder 310 of FIG. 3, an encoder neural network 410 of FIG. 4, and/or an encoder neural network 510 of FIG. 5) configured to convert the input image data into data of a lower dimensional vector (e.g., latent vector). The encoding module 112 may include a single encoder or a plurality of encoders.

The encoding module 112 may receive the input image data, and may obtain first vector data by inputting the input image data to a neural network model-based first encoder and encoding the input image data by the first encoder.

A bit depth may determine the accuracy and range of data represented by bits. The bit depth may indicate how much information each data element may hold. The larger the bit depth, the more information each data element may hold. The bit depth may indicate the number of bits by which a vector value (e.g., a latent vector value) included in encoded data is represented, and the size and precision of a vector value may be determined by a specified bit depth. For example, a first bit depth may be greater than a second bit depth, but embodiments are not necessarily limited thereto. In one or more embodiments, the first bit depth may be less than the second bit depth.

The encoded data generated by the first processor 110 may be transmitted from the first processor 110 to the second processor 120, or may be transmitted to the second processor 120 after being output from the first processor 110 and stored in the memory 130 (e.g., a buffer memory in the memory 130). The encoded data may be transmitted to the memory 130 or the second processor 120 via the communication bus 140. The encoded data may be transmitted in the form of a bitstream (e.g., a bitstream 340 of FIG. 3 and/or a bitstream 450 of FIG. 4). In one or more embodiments, the encoded data may be transmitted in the form of a bitstream after passing through entropy encoding (e.g., entropy encoding 335 of FIG. 3) by an entropy encoder (e.g., an entropy encoder 440 of FIG. 4 and/or an entropy encoder 530 of FIG. 5). The entropy encoding may be a coding method that varies the length of code representing a symbol based on the probability of occurrence of the symbol corresponding to a vector value grouped in a channel unit. The entropy encoding may assign a short code to a frequently occurring symbol while assigning a long code to an infrequently occurring symbol. The entropy encoding may eliminate statistical redundancy in the input image data.

The second processor 120 may receive the encoded data and perform decoding based on the received encoded data to generate restored data (or decoded data or decompressed data). In a case where the second processor 120 receives a bitstream generated through the entropy encoding, the decoding module 124 (e.g., a decoding module 207 of FIG. 2, a decoding module 307 of FIG. 3, a decoding module 407 of FIG. 4, and/or a decoding module 507 of FIG. 5) of the second processor 120 may perform entropy decoding (e.g., entropy decoding 360 of FIG. 3) on the received bitstream. The entropy decoding may be performed by an entropy decoder (e.g., an entropy decoder 460 of FIG. 4 and/or an entropy decoder 540 of FIG. 5) included in the decoding module 124. By the entropy decoding, the encoded data included in the bitstream may be restored.

The decoding module 124 may perform decoding on the encoded data using a neural network model-based first decoder (e.g., a decoder 260 of FIG. 2, a decoder 370 of FIG. 3, a decoder neural network 480 of FIG. 4, and/or a decoder neural network 560 of FIG. 5) to obtain restored data corresponding to the input image data.

In a data encoding-decoding structure, there may be one encoder and one decoder, but there may also be a plurality of encoders and decoders. In a case where there are a plurality of encoders and decoders, each of the decoders may have a pairwise relationship with any one of the encoders. For example, in a case where the encoders include a first encoder and a second encoder, the decoders may include a first decoder corresponding to the first encoder and a second decoder corresponding to the second encoder. In this case, the first encoder and the first decoder may form a first pair, and the second encoder and the second decoder may form a second pair. The number of decoders may be the same as or less than the number of encoders but embodiments are not necessarily limited to the number of encoders. For example, there may be a plurality of encoders but only a single decoder.

As described above, the encoding module 112 may receive input image data, and obtain first vector data by inputting the received input image data to the first encoder and encoding the input image data by the first encoder. The encoding module 112 may obtain second vector data by inputting the input image data to a neural network model-based second encoder and encoding the input image data by the second encoder. The encoding module 112 may convert the second vector data into second vector data of a third bit depth. The third bit depth may be smaller than the first bit depth and larger than the second bit depth. For example, the first bit depth may be 8 bits, the second bit depth may be 4 bits, and the third bit depth may be 6 bits. The second vector data may have the same data size as the first vector data.

The encoding module 112 may generate encoded data including a selected vector value and identification data for identifying a decoder that is to decode the selected vector value. The identification data may include a flag value or index value for identifying, from among a plurality of decoders corresponding to a plurality of encoders, a decoder that is to perform decoding for each vector value included in the encoded data. The flag value or index value in the identification data may be a value for identifying a specific encoder-decoder pair among a plurality of encoder-decoder pairs.

The encoded data and identification data generated by the first processor 110 may be transmitted from the first processor 110 to the second processor 120, or may be transmitted to the second processor 120 after being output from the first processor 110 and stored in the memory 130 (e.g., a buffer memory in the memory 130). The encoded data and identification data may be transmitted to the memory 130 or the second processor 120 via the communication bus 140. The encoded data and identification data may be transmitted in the form of a bitstream. According to one or more embodiments, the encoded data and identification data may be encoded through entropy encoding by an entropy encoder and may then be transmitted in the form of a bitstream.

The second processor 120 may perform decoding based on the received encoded data and identification data to generate restored data. In a case where the second processor 120 receives a bitstream generated through the entropy encoding, the decoding module 124 of the second processor 120 may perform the entropy decoding on the received bitstream. The decoding module 124 of the second processor 120 may receive the encoded data and identification data, and select a decoder from a plurality of decoders to decode a vector value included in the encoded data based on the identification data. The decoding module 124 may perform decoding on the vector value included in the encoded data using the selected decoder to obtain the restored data corresponding to the input image data. In this case, the decoding module 124 may identify a decoder that is to decode the encoded data from among the decoders based on a value (e.g., a flag value or index value) of the identification data, and perform a decoding process by inputting the encoded data to the identified decoder.

Although the encoding process above is described as performed by the encoding module 112 of the first processor 110 and the decoding process is described as performed by the decoding module 124 of the second processor 120, this is provided only for ease of explanation, and embodiments are not limited thereto. The encoding process may be performed by the encoding module 122 of the second processor 120 and the decoding process may be performed by the decoding module 114 of the first processor 110.

The encoding module 112 and the encoding module 122 may each be referred to as a neural encoder, and the decoding module 114 and the decoding module 124 may each be referred to as a neural decoder. The neural encoder may be applied to various devices that compress an image (or video), and the neural decoder may be applied to various devices that restore the compressed image (or video). The encoding module 112 and the decoding module 114 may perform the functions of a neural codec, and the encoding module 122 and decoding module 124 may also perform the functions of a neural codec. The first processor 110 and/or the second processor 120 capable of performing the functions of the neural codec may be implemented in a personal computer (PC), a display device (e.g., a television (TV), a projector, etc.), a streaming service server, a content storage device, and/or a portable device. The portable device may include, as non-limiting examples, a laptop computer, a mobile phone, a smartphone, a tablet PC, a mobile Internet device (MID), a personal digital assistant (PDA), an enterprise digital assistant (EDA), a digital still camera, a digital video camera, a portable multimedia player (PMP), a personal navigation device or portable navigation device (PND), a handheld game console, and/or a smart device. The smart device may include, as non-limiting examples, a smartwatch, a smart band, and/or a smart ring.

In one or more embodiments, data processing between the first processor 110 and the second processor 120 may be performed in a frame buffer compression environment where image data (or video data) is compressed between intellectual property (IP) units (e.g., a GPU, an NPU, a video processor, a display processor, etc.) within a SoC and is then transmitted via the memory 130 (e.g., a dynamic random-access memory (RAM) (DRAM)). In this case, the memory 130 may include a frame buffer for temporarily storing the compressed image data. When the image data is transmitted to another IP unit, the image data may be compressed and transmitted due to a footprint, which is a constraint that represents a limit on a maximum data size per block area. For example, assuming that the image data to be transmitted has a data size of 192 bytes and a footprint constraint is 50%, a maximum data size that the compressed image data may have when transmitted may be 96 bytes. This footprint constraint may impose a constraint on the size of a latent vector value transmitted between IP units and on a bit depth (or bit-precision) that determines the precision of the latent vector value. The footprint constraint may make it difficult to increase compression performance despite an increase in the neural network capacity (e.g., the number of layers or the number of parameters) of an encoder and/or decoder implemented as a neural network model.

According to one or more embodiments described herein, compressing data by compounding bit depths of vector values (e.g., latent vector values) included in encoded data may provide improved performance (e.g., a restored image of better quality or a higher compression ratio), while satisfying the footprint constraint, compared to configuring the vector values included in the encoded data as a single bit depth. In addition, according to one or more embodiments, appropriately using a plurality of encoders and decoders with different characteristics to compress data may provide improved performance (e.g., a restored image of better quality or a higher compression ratio), while satisfying the footprint constraint, compared to using only one encoder. According to one or more embodiments, improving a data compression ratio may reduce bandwidth between an IP unit in a SoC and a memory, reducing power consumption. To compress and transmit an image, a random-access technology that loads and processes only a required block area, rather than the entire image, may be used to select a block area, which is a local area in the image, and perform a compression process on the selected block area.

The example embodiments described herein may be applied to neural network model-based frame buffer compression (FBC) techniques. Further, the example embodiments may also be applied to various applications that have an encoder-decoder structure, in addition to an application of image compression. For example, the example embodiments may be applied to systems with a limited number of dictionaries, such as, a vector-quantized variational autoencoder (VQ-VAE) structure, and may also be applied to video compression or audio compression.

FIG. 2 is a diagram illustrating an example structure and operation of an electronic device according to one or more embodiments. Referring to FIG. 2, according to one or more embodiments, an electronic device 200 may include an encoding module 205 including a neural encoder and a decoding module 207 including a neural decoder to perform encoding and decoding. The electronic device 200 may include, for example, but is not necessarily limited to, a neural codec including the neural encoder and the neural decoder. The neural codec including the neural encoder and/or neural decoder may be implemented, for example, on a mobile SoC with NPUs.

The neural encoder may correspond to a neural network that performs encoding by an encoder 210 and performs clipping 220 and quantization 230. The neural encoder may be applied to various product groups that perform image (video) compression. The neural decoder may correspond to a neural network that performs decoding by a decoder 260. The neural decoder may be applied to various product groups that perform image (video) restoration.

The encoding module 205 may input image data 201 to the encoder 210 (e.g., gₐ) and encode the input image data 201 to generate a first latent vector corresponding to the input image data 201. In this case, the input image data 201 may correspond to any data that may be represented in a two-dimensional (2D) form, in addition to image data.

The encoder gₐ 210 may extract features from the input image data 201 and generate the first latent vector with reduced dimensionality. The encoder gₐ 210 may extract the first latent vector from the input image data 201 and encode the first latent vector, using various deep learning-based image compression methods. The encoder gₐ 210 may include, for example, but is not necessarily limited to, a convolutional neural network (CNN) or a deep neural network (DNN). The encoder gₐ 210 may also be referred to as an “encoding network” or an “encoder neural network (NN).”

The encoding module 205 may perform the clipping 220 on the first latent vector based on a preset target compression ratio to adjust a size of the first latent vector to be within a certain fixed range. In this case, the “preset target compression ratio” may refer to a minimum compression ratio required by a device, which corresponds to a footprint constraint. In image compression technology, the footprint constraint may primarily refer to a limit on storage space and transmission bandwidth. The footprint constraint may be an important factor in processing a high-definition video. The target compression ratio may also be referred to as a “minimum compression ratio” or a “footprint.” Here, constraints for satisfying the footprint may include a bit depth and a shape or size of a latent vector. The first latent vector may be a three-dimensional (3D) vector represented in the form of {channel, height, width}. The shape (or size) of the first latent vector may indicate the number of numerals (or values) in the vector. The number of numerals (or values) in the vector may be obtained by multiplying channel, height, and width, i.e., channel*height*width. The encoding module 205 may perform the clipping 220 to clip the range of the first latent vector to a certain range corresponding to the target compression ratio. The encoding module 205 may perform the quantization 230 to quantize the clipped first latent vector and generate a second latent vector 240. The encoding module 205 may adjust the range of the first latent vector to a fixed range, for example, a fixed range of 8 bits (−128 to +127) or a fixed range of 6 bits (−32 to +32), to generate the quantized second latent vector 240. The encoding module 205 may also generate an integer-type second latent vector 240 with a certain limited range through the clipping 220 based on the target compression ratio, without performing entropy coding.

The encoding module 205 may perform the quantization 230 by a quantizer to quantize the first latent vector with the range adjusted by the clipping 220, and generate the second latent vector 240. The quantizer may perform various quantization processes on the latent vector output as a result of the clipping 220 to generate the integer-type second latent vector 240 with the certain range. For example, the quantizer may employ various quantization methods such as scalar quantization, vector quantization, and/or embedded quantization, in addition to quantization by applying a round-off (or rounding) operation, to quantize a latent vector.

Simply reducing the dimensionality of the first latent vector may not result in a sufficiently large reduction in information to be used for compression as is, and thus the encoding module 205 may generate the second latent vector 240 with an amount of information reduced through the clipping 220 and the quantization 230. The encoding module 205 may then transmit the second latent vector 240 to the decoding module 207.

The decoding module 207 may, when receiving a second latent vector 240, restore the second latent vector 250 by the decoder 260 (e.g., gₛ) to generate output data 203. The decoder gₛ 260 may also be referred to as a “decoding network” or a “decoder neural network (NN).”

The electronic device 200 may train the encoder gₐ 210 and the decoder gₛ 260 based on a difference between the input image data 201 and the output data 203 that is obtained by restoring the input image data 201 by the decoder gₛ 260.

According to one or more embodiments, the encoding module 205 may satisfy a footprint, which is one of the major constraints of hardware implementation, by the clipping 220 and the quantization 230 performed on a first latent vector that is an output of the encoder 210 to adjust the latent vector (e.g., the second latent vector 240) to be of an integer type of a fixed range. In this case, the fixed range may be represented as a bit depth, and the encoding module 205 may adjust the size of the first latent vector based on the bit depth to respond to such a footprint constraint. For example, when encoding a 12-bit YUV (3 channels×128 pixels) image block into an 8-bit latent vector (36 channels×1 height×8 width), the encoding module 205 may ensure at least 50% compression for any image. The encoding module 205 may predefine constraints (e.g., a target compression ratio and/or an additional compression ratio) on the second latent vector 240 and train and optimize a neural network to minimize performance loss accordingly.

In general, entropy coding of a latent vector may be performed during lossy/lossless image (or video) compression. However, in the embodiments described above with reference to FIG. 2, the encoding module 205 may directly transmit the second latent vector 240 without the entropy coding because the second latent vector 240 is output through the clipping 220 to satisfy the target compression ratio. Therefore, without the entropy coding, the encoding module 205 may reduce the usage area of hardware, i.e., a hardware footprint.

FIG. 3 is a diagram illustrating an example structure and operation of an electronic device according to one or more embodiments. Referring to FIG. 3, according to one or more embodiments, an electronic device 300 may include an encoding module 305 including a neural encoder and a decoding module 307 including a neural decoder.

For the description of an encoder gₐ 310, clipping 315, quantization 320, and a second latent vector 325 in FIG. 3, reference may be made to the preceding description regarding the encoder 210, the clipping 220, the quantization 230, and the second latent vector 240 in FIG. 2. Hereinafter, configurations and operations that differ from what has been described above with reference to FIG. 2 will only be described.

The encoding module 305 may set a value of a bypass flag corresponding to the second latent vector 325 in operation 330. The bypass flag may correspond to information indicating whether to perform entropy coding on a corresponding latent vector. The bypass flag may correspond to, for example, 1-bit information included in an outgoing frame (or a transmit frame).

The encoding module 305 may set the value of the bypass flag corresponding to the second latent vector 325 based on whether to perform the entropy coding (e.g., the entropy encoding 335). As will be described in more detail below, the encoding module 305 may determine whether to perform the entropy coding based on the second latent vector 325 in relation to a target compression ratio and/or an additional compression ratio.

For example, in response to a determination to bypass the entropy encoding 335 for the second latent vector 325, the encoding module 305 may set the value of the bypass flag to a first value (e.g., “1”). In this case, the encoding module 305 may directly transmit the second latent vector 325 to the decoding module 307, without performing the entropy encoding 335.

Alternatively, in response to a determination to perform the entropy encoding 335 on the second latent vector 325, the encoding module 305 may set the value of the bypass flag to a second value (e.g., zero “0”) that is different from the first value. In this case, the encoding module 305 may generate a bitstream 340 by performing the entropy encoding 335 on the second latent vector 325.

The encoding module 305 may generate the final bitstream 340 with an amount of information reduced through the entropy encoding 335 and transmit the bitstream 340 to the decoding module 307.

The decoding module 307 may read the value of the bypass flag included in incoming data (e.g., receive data) 350 in operation 355. The decoding module 307 may determine whether to perform entropy decoding 360 on the incoming data 350 based on the read value of the bypass flag.

For example, when the value of the bypass flag included in the incoming data 350 is “1,” it may indicate that the incoming data 350 is data obtained with the entropy encoding bypassed. In this case, the decoding module 307 may determine the incoming data 350 to be a third latent vector 365, and may decode the third latent vector 365 by a decoder gₛ 370 to generate output data 303. The output data 303 may correspond to a restored version of the input image data 301.

Alternatively, when the value of the bypass flag included in the incoming data 350 is “0,” it may indicate that the incoming data 350 is data obtained through the entropy coding. In this case, the decoding module 307 may perform the entropy decoding 360 on the incoming data 350 to obtain the third latent vector 365.

The decoding module 307 may decode the third latent vector 365 by the decoder gₛ 370 to generate the output data 303.

The electronic device 300 may train the encoder gₐ 310 and the decoder gₛ 370 based on a difference between the input image data 301 and the input image data 301 restored by the decoder gₛ 370, i.e., a difference between the input image data 301 and the output data 303.

As described above with reference to FIG. 2, in one or more embodiments, the encoding module 305 may transmit the second latent vector 325 directly without the entropy coding because the second latent vector 325 is output through the clipping 315. That is, the compression ratio of the second latent vector 325 may be greater than or equal to the target compression ratio.

The encoding module 305 may also perform the entropy encoding 335 on the second latent vector 325 to convert it into the bitstream 340 to achieve an additional compression ratio. However, in a case where the entropy encoding 335 rather prevents a footprint constraint from being satisfied, the encoding module 305 may directly transmit the second latent vector 325 through a bypass path instead of the bitstream 340. In other words, the encoding module 305 may determine whether to directly transmit the second latent vector 325 of an integer type, or transmit it in the form of the bitstream 340 by performing the entropy encoding 335 on the second latent vector 325, for each data.

The electronic device 300 may reliably learn a symbol table used for the entropy encoding 335 by fixing a latent vector range and training a neural network (e.g., the encoder 310 and the decoder 370). For example, in a learning-based image compression model, an entropy coder that performs the entropy encoding 335 may use the symbol table to learn all symbols in the second latent vector 325 and information about the frequency of occurrence of each of the symbols. However, when the range of the second latent vector 325 is changed, data with a different distribution from the learned data may be input. In such a case, a symbol that is not present in the symbol table may be output, causing an error.

In one or more embodiments, outputting the second latent vector 325 of the size within the fixed range may prevent such a potential error caused by a symbol that is not present in the symbol table as described above and may learn a distribution within the fixed range, and may thus more efficiently optimize the entropy coder performing the entropy encoding 335 and/or entropy decoding 360.

In one or more embodiments, training the neural network may minimize information loss that may occur due to the clipping 315.

FIG. 4 is a diagram illustrating an example structure and operation of an electronic device according to one or more embodiments. Referring to FIG. 4, diagram 400 illustrates a process in which an encoding module 405 compresses and transmits a 12-bit YUV image block 401 of a size of 3×4×32 (channel×height×width) and a decoding module 407 restores it to an image 403 of the same size as the size of 3×4×32 (channel×height×width).

For example, assuming a scenario in which a target compression ratio (or a footprint constraint) is 50% (2:1 compression), the encoding module 405 may encode the 12-bit YUV image block 401 of the size 3×4×32 (channel×height×width) into an 8-bit integer-type latent vector of a size of 36×1×8 (channel×height×width). The encoding module 405 may perform clipping and rounding on a first latent vector to an 8-bit range, for example, [−128, +127], after a convolution operation by an encoder neural network (NN) 410 to satisfy the target compression ratio (e.g., to be greater than or equal to the target compression ratio).

Alternatively, assuming a scenario in which the target compression ratio is 67% (1:3 compression), the encoding module 405 may encode the 12-bit YUV image block 401 of the size 3×4×32 (channel×height×width) into a 6-bit integer-type latent vector of a size of 32×1×8 while maintaining a kernel size of a convolutional layer. The encoding module 405 may perform clipping and rounding on the first latent vector to a 6-bit range, for example, [−32, +31], after a convolution operation by the encoder neural network 410 to satisfy the target compression ratio (e.g., to be greater than or equal to the target compression ratio).

According to one or more embodiments, the encoding module 405 may perform clipping and quantization on the first latent vector, which is a resulting output from the encoder, into a pre-learned bit depth. In this case, the encoding module 405 may adjust the size of the second latent vector 430, in addition to the bit depth, to satisfy the target compression ratio (e.g., to be greater than or equal to the target compression ratio) (e.g., a footprint constraint).

For example, the encoding module 405 may allow the 12-bit YUV image block 401 of the size 3×4×32 (channel×height×width) to pass through the encoder neural network 410 including the convolution operation with a 4×4 kernel, and then perform clipping and quantization 420 to be an 8-bit range (e.g., −128 to +127) to generate the second latent vector 430 of the size 36×1×8 (channel×height×width).

If the second latent vector 430 that exceeds a clipping range (e.g., the 8-bit range) is numerous, a large information loss may occur due to the clipping, but the encoding module 405 may apply in advance the clipping in a learning process of the encoder neural network 410 to minimize the loss. That is, the encoding module 405 may learn by constraining a range of a coding table of an entropy coder (e.g., an entropy encoder 440 and an entropy decoder 460) to be within the 8-bit range (e.g., −128 to +127), the same as the range of the second latent vector 430. In this case, the coding table may be learned such that respective channels of the second latent vector 430 have different frequencies of occurrence within the 8-bit range described above, and the encoding module 405 may use the learned coding table to convert the second latent vector 430 into a bitstream 450 and transmit the bitstream 450.

As described above, the encoding module 405 may also transmit the second latent vector 430 directly without converting it into the bitstream 450. A portion indicated as “bypass” in FIG. 4 may correspond to a flow in such a case of direct transmission.

For example, as a result of performing entropy coding on the second latent vector 430 by the entropy encoder 440, there may be a very sparse symbol, resulting in a bit per pixel (BPP) value that does not satisfy a constraint of the target compression ratio or resulting in a compression ratio that is sufficiently low to be insignificant based on byte-align. In this case, the encoding module 405 may set the bypass flag to “1” and bypass the entropy encoder 440 in step 455 to transmit the second latent vector 430 directly to the decoding module 407.

For example, in a case where the bypass flag included in incoming data (or received data) is “1,” the decoding module 407 may input the second latent vector 430 bypassed in step 455 directly into a decoder neural network 480 to generate the decoded image 403, i.e., a restored original image block.

In contrast, in a case where the result of the entropy coding by the entropy encoder 440 satisfies the target compression ratio (e.g., to be greater than or equal to the target compression ratio), the encoding module 405 may set the bypass flag to “0” and perform the entropy coding on the second latent vector 430 by the entropy encoder 440 to generate the bitstream 450. The encoding module 405 may transmit the bitstream 450 to the decoding module 407. In this case, the bypass flag may be included in an outgoing frame (or a transmit frame) including the bitstream 450 or the second latent vector 430.

Upon receiving the incoming data from the encoding module 405, the decoding module 407 may process the received data differently depending on a value of the bypass flag included in the received data.

For example, in a case where the bypass flag included in the incoming data has a value of “0,” the decoding module 407 may convert the bitstream 450 back into a third latent vector 470 by the entropy decoder 460, using the coding table. The third latent vector 470 may have a size of 36×1×8 (channel×height×width), similar to the second latent vector 430. The decoding module 407 may allow the third latent vector 470 to pass through the decoder neural network 480 to generate the decoded image 403, i.e., the restored original image.

According to one or more embodiments, the encoding module 405 may further include an automatic determination module 490 configured to automatically determine bit depths and sizes that satisfy various compression ratio scenarios. The automatic determination module 490 may be included at an uppermost end of the neural network during training of the neural network. The encoding module 405 may define, in the automatic determination module 490, a range (e.g., a candidate list) of bit depths and sizes of latent vectors that satisfy the target compression ratio (e.g., to be greater than or equal to the target compression ratio), and then iterate over candidates included in the candidate list to train a neural network that satisfies each condition. Based on a final training result, the encoding module 405 may select a model with the most suitable compression ratio and image quality and use the model for inference. As such, the automatic determination module 490 may be used only for training but excluded for inference.

FIG. 5 is a diagram illustrating an example structure and operation of an electronic device according to one or more embodiments. Referring to FIG. 5, diagram 500 illustrates a process in which an encoding module 505 compresses and transmits, for example, (image) sub-blocks 501 of a size of 4×32 (height×width) and a decoding module 507 restores it to a decoded image 503 of a size of 4×32 (height×width).

The encoding module 505 may adaptively determine whether to perform entropy coding by an entropy encoder 530, for each of the sub-blocks 501. In this case, the sub-blocks 501 may be image blocks obtained by dividing, by the encoding module 505, input image data into blocks of a certain size or image blocks generated by the encoding module 505 to have a certain size.

For example, in the case of dividing a single piece of input image data (e.g., an image block) into multiple sub-blocks (e.g., the sub-blocks 501) and processing them, the encoding module 505 may determine whether to bypass the entropy encoder 530 for each sub-block. In this case, the sub-blocks 501 may be defined as various sizes within the size of the original image block.

For example, the encoding module 505 may divide the input image data into eight sub-blocks (e.g., the sub-blocks 501) and allow them to pass through an encoder neural network 510 in parallel, as shown in FIG. 5.

It may allow the eight sub-blocks 501 to pass through the encoder neural network 510 to generate a first latent vector 520 corresponding to each of the eight sub-blocks 501. In this case, the first latent vector 520 may be limited in size to an 8-bit range through clipping and quantization described above.

The encoding module 505 may determine whether to perform entropy coding on the first latent vector 520 corresponding to each of the sub-blocks 501, that is, for each sub-block.

For example, of the eight sub-blocks 501, sub-blocks 1, 4, 5, and 7 may have low image complexity, while sub-blocks 0, 2, 3, and 6 may have high image complexity. As used herein, “image complexity” may correspond to an application of the concept of “complexity,” which is generally a measure of the performance and efficiency of an algorithm, to image processing. For example, image complexity may refer to an analysis of time complexity or space complexity of an image processing algorithm or a numerical representation of the amount of information of an image (e.g., the amount of information based on the number of objects, colors, lighting changes, etc.) or the structure, texture, and the like of the image. The complexity may be categorized into time complexity and space complexity. The time complexity, which is a concept representing the time required for an algorithm to solve a problem, may indicate how much time is used by the algorithm depending on the size of input data. The space complexity may correspond to a measure of how much space (memory) is required to the execution and completion of a program.

The encoding module 505 may bypass the entropy encoding performed by the entropy encoder 530 because the encoding module 505 does not need to perform additional compression on the first latent vector 520 corresponding to sub-blocks 1, 4, 5, and 7, which have relatively high compression ratio due to a low image complexity. Based on the bypass, the encoding module 505 may transmit an image frame including the first latent vector 520 corresponding to sub-blocks 1, 4, 5, and 7 directly to the decoding module 507.

Upon receiving the first latent vector 520 corresponding to sub-blocks 1, 4, 5, and 7 as a second latent vector 550, the decoding module 507 may input the first latent vector 520 corresponding to sub-blocks 1, 4, 5, and 7 into a decoder neural network 560 to decode it therein to output the decoded image 503 corresponding to sub-blocks 1, 4, 5, and 7, i.e., restored image blocks 1, 4, 5, and 7. In this case, the decoded image 503 may have the size of 4×32 (height×width).

On the other hand, the encoding module 505 may perform additional compression by entropy coding on the first latent vector 520 corresponding to sub-blocks 0, 2, 3, and 6, which have a relatively low compression ratio due to a high image complexity (e.g., are less than the target compression ratio and therefore do not satisfy the target compression ratio condition). The encoding module 505 may input the first latent vector 520 corresponding to sub-blocks 0, 2, 3, and 6 to the entropy encoder 530, respectively, and perform the entropy encoding to generate bitstreams (e.g., bitstream B0, B2, B3, and B6) respectively corresponding to sub-blocks 0, 2, 3, and 6. In this case, the encoding module 505 may transmit, to the decoding module 507, an outgoing frame (e.g., a transmit frame) including the bitstreams B0, B2, B3, and B6 respectively corresponding to sub-blocks 0, 2, 3, and 6.

The decoding module 507 may perform entropy decoding on the outgoing frame including the bitstreams B0, B2, B3, and B6 respectively corresponding to sub-blocks 0, 2, 3, and 6 by an entropy decoder 540 to generate the second latent vector 550 corresponding to sub-blocks 0, 2, 3, and 6. The decoding module 507 may input the second latent vector 550 corresponding to sub-blocks 0, 2, 3, and 6 into the decoder neural network 560 and decode it to output the decoded image 503 corresponding to sub-blocks 0, 2, 3, and 6, i.e., restored image blocks 0, 2, 3, and 6.

The decoder neural network 560 may decode the first latent vector 520 corresponding to sub-blocks 1, 4, 5, and 7 and the second latent vector 550 corresponding to sub-blocks 0, 2, 3, and 6 all at once, or may decode them sequentially in order of arrival.

As will be described in more detail below, the encoding module 505 may set a value of a bypass flag corresponding to the first latent vector 520 of each of the sub-blocks 501 depending on whether to perform the entropy coding. For example, in response to bypassing the entropy coding on a sub-block “a,” the encoding module 505 may set the value of the bypass flag corresponding to the sub-block a to “1.” In contrast, in response to performing the entropy coding on a sub-block “b,” the encoding module 505 may set the value of the bypass flag corresponding to the sub-block b to “0.”

As described above, the encoding module 505 may adaptively determine whether to perform the entropy coding for each piece of input image data or each of the sub-blocks 501 of the input image data, based on a difference in compression ratio according to image complexity. In the case of dividing the input image data into the sub-blocks 501, the encoding module 505 may determine whether to perform the entropy coding on each of the sub-blocks 501 and maximally compress an area in the input image data from which a compression ratio gain is to be obtained, thereby achieving an optimal compression ratio even under a footprint constraint.

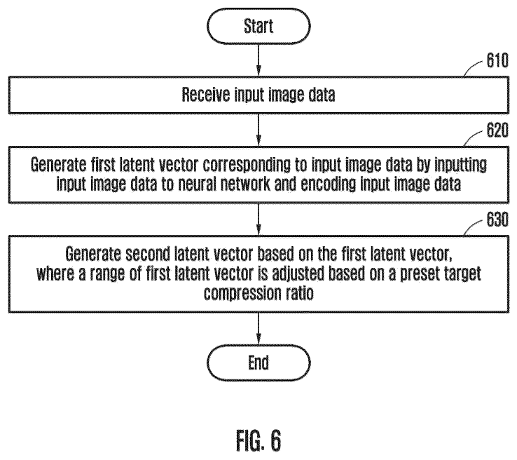

FIG. 6 is a flowchart illustrating an image processing method of an electronic device performing encoding according to one or more embodiments. According to one or more embodiments, operations to be described below may be performed sequentially but are not necessarily performed sequentially. For example, the order of the operations may be changed, and at least two operations may be performed in parallel.

Referring to FIG. 6, according to one or more embodiments, an electronic device may include, but is not necessarily limited to, an encoding module (e.g., the encoding module 112 of FIG. 1, the encoding module 205 of FIG. 2, the encoding module 305 of FIG. 3, the encoding module 405 of FIG. 4, and/or the encoding module 505 of FIG. 5). The electronic device may generate a second latent vector through operations 610 to 630 described below.

In operation 610, the electronic device may receive input image data. The input image data may be, for example, a 2D image frame. Alternatively, the input image data may be an input image block or a plurality of sub-blocks. In this case, a transmitting device may divide the input image data including an input image block into sub-blocks.

In operation 620, the electronic device may generate a first latent vector corresponding to the input image data by inputting the input image data received in operation 610 into a neural network (e.g., an encoder neural network) and encoding the input image data.

In operation 630, the electronic device may generate a second latent vector based on the first latent vector, where a range of the first latent vector generated in operation 620 is adjusted based on a preset target compression ratio. The electronic device may clip the range of the first latent vector to a certain range corresponding to the target compression ratio. The electronic device may quantize the clipped first latent vector to generate the second latent vector. The electronic device may adjust the range of the first latent vector to, for example, an 8-bit (−128 to 127) fixed range, to generate a quantized second latent vector. The electronic device may generate the second latent vector of integer type within a limited range, without entropy coding, by the clipping based on the target compression ratio.

The electronic device may output the second latent vector generated in operation 630.

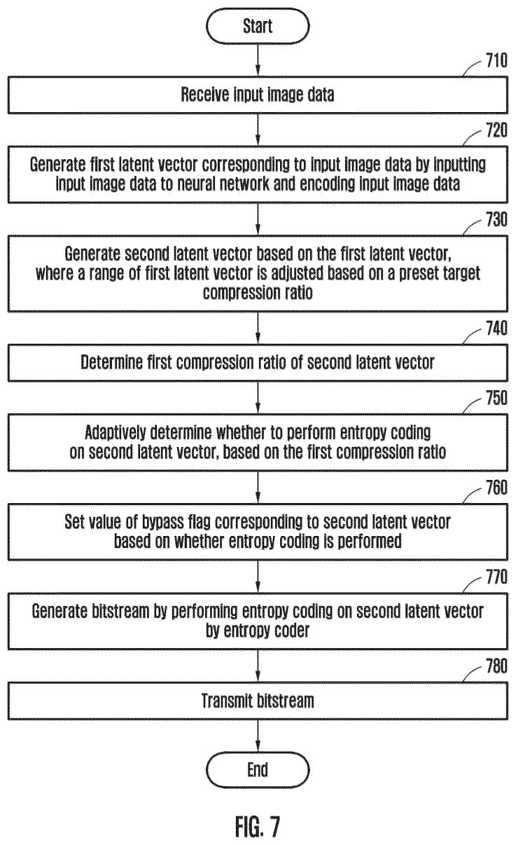

FIG. 7 is a flowchart illustrating an image processing method of an electronic device performing encoding according to one or more embodiments. Referring to FIG. 7, according to one or more embodiments, an electronic device may transmit a bitstream through operations 710 to 780 described below.

In operation 710, the electronic device may receive input image data. The input image data may be, for example, a 2D image frame. Alternatively, the input image data may be an input image block or a plurality of sub-blocks.

In operation 720, the electronic device may generate a first latent vector corresponding to the input image data by inputting the input image data received in operation 710 into a neural network and encoding the input image data.

In operation 730, the electronic device may generate a second latent vector based on the first latent vector, where a range of the first latent vector generated in operation 720 is adjusted based on a preset target compression ratio.

In operation 740, the electronic device may determine a first compression ratio of the second latent vector generated in operation 730. The electronic device may determine whether the first compression ratio of the second latent vector determined in operation 740 satisfies the target compression ratio (e.g., to be greater than or equal to the target compression ratio).

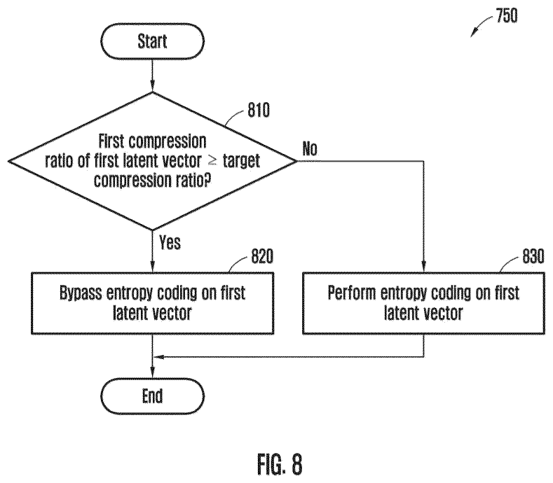

In operation 750, the electronic device may adaptively determine whether to perform entropy coding on the second latent vector based on the first compression ratio. A method by which the electronic device adaptively determines whether to perform entropy coding will be described in more detail below with reference to FIG. 8. That is, the electronic device may determine whether to perform entropy coding on the second latent vector based on whether the first compression ratio of the second latent vector is greater than or equal to the target compression ratio, or whether the first compression ratio is less than the target compression ratio.

In operation 760, the electronic device may set a value of a bypass flag corresponding to the second latent vector based on whether to perform the entropy coding as determined in operation 750. In this case, the bypass flag may correspond to information indicating whether to transmit an encoded latent vector directly (i.e., bypass the entropy coding) or to transmit an encoded latent vector after performing the entropy coding on a latent vector and performing lossless compression. For example, when bypassing the entropy coding for the latent vector, a transmitting device may set the bypass flag to a first value (e.g., “1”). Alternatively, when performing the entropy coding on the second latent vector to generate a bitstream, the transmitting device may set the bypass flag to a second value (e.g., “0”) that is different from the first value.

In operation 770, the electronic device may generate a bitstream by performing the entropy coding on the second latent vector by an entropy coder. In this case, the bypass flag may be set to the second value (e.g., “0”).

In operation 780, the electronic device may transmit (or output) the bitstream generated in operation 770.

FIG. 8 is a flowchart illustrating a method performed by an electronic device to adaptively determine whether to perform entropy coding on a latent vector according to one or more embodiments. Referring to FIG. 8, according to one or more embodiments, an electronic device may perform entropy coding or bypass the entropy coding through operations 810 to 830 described below.

In operation 810, the electronic device may determine whether a first compression ratio of a latent vector is greater than or equal to a target compression ratio. In operation 820, in response to the first compression ratio of the latent vector being determined to be greater than or equal to the target compression ratio in operation 810, the electronic device may bypass the entropy coding for the latent vector.

In operation 830, in response to the first compression ratio of the latent vector being determined to be less than the target compression ratio in operation 810, the electronic device may perform the entropy coding on the latent vector.

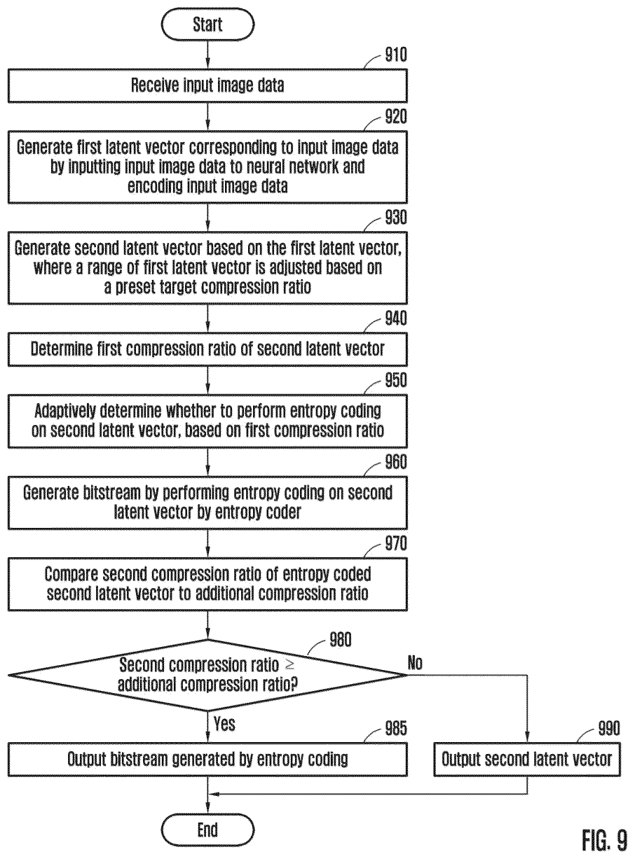

FIG. 9 is a flowchart illustrating an image processing method of an electronic device performing encoding according to one or more embodiments. Referring to FIG. 9, according to one or more embodiments, an electronic device may output a bitstream or a first latent through operations 910 to 990 described below.

In operation 910, the electronic device may receive input image data. The input image data may be, for example, a 2D image frame. Alternatively, the input image data may be an input image block or a plurality of sub-blocks.

In operation 920, the electronic device may generate a first latent vector corresponding to the input image data by inputting the input image data received in operation 910 to a neural network and encoding the input image data.

In operation 930, the electronic device may generate a second latent vector based on the first latent vector where a range of the first latent vector generated in operation 920 is adjusted based on a preset target compression ratio.

In operation 940, the electronic device may determine a first compression ratio of the second latent vector generated in operation 930. The electronic device may determine whether the first compression ratio of the second latent vector satisfies the target compression ratio (e.g., whether the first compression ratio if greater than or equal to the target compression ratio).

In operation 950, the electronic device may adaptively determine whether to perform entropy coding on the second latent vector based on whether the first compression ratio of the second latent vector satisfies the target compression ratio (e.g., whether the first compression ratio is greater than or equal to the target compression ratio). For a method by which the electronic device adaptively determines whether to perform entropy coding, reference may be made to what has been described above with reference to FIG. 4.

In operation 960, the electronic device may generate a bitstream by performing the entropy coding on the second latent vector by an entropy coder. When it is determined in operation 950 to perform the entropy coding in response to the first compression ratio of the second latent vector being less than the target compression ratio (e.g., not satisfying the target compression ratio), the electronic device may generate the bitstream by performing the entropy coding on the second latent vector by the entropy coder. In this case, a coding table corresponding to the entropy coder may be learned by reflecting therein the range of the second latent vector adjusted based on the preset target compression ratio.

In operation 970, the electronic device may compare a second compression ratio of the second latent vector that is entropy-coded in operation 960 to an additional compression ratio. The additional compression ratio may correspond to one of the constraints on the first latent vector (e.g., 240), similar to the target compression ratio, which represents the minimum compression ratio required by the device depending on the scenario. The additional compression ratio may indicate a compression ratio considered in addition to the target compression ratio and may be used for comparison with the compression ratio of the first latent vector. The electronic device may output the bitstream generated by the entropy coding or the second latent vector, based on a result of comparing the second compression ratio and the additional compression ratio.

In operation 980, the electronic device may determine whether the second compression ratio of the entropy-coded second latent vector is greater than or equal to the additional compression ratio. In operation 985, in response to the second compression ratio being determined to be greater than or equal to the additional compression ratio in operation 980, the electronic device may output the bitstream generated by the entropy coding. In operation 990, in response to the second compression ratio being determined to be less than the additional compression ratio in operation 980, the electronic device may output the second latent vector.

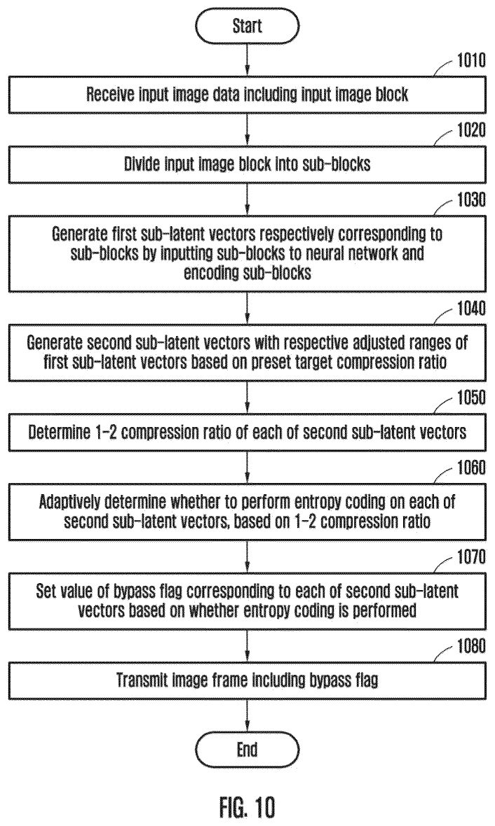

FIG. 10 is a flowchart illustrating an image processing method of an electronic device performing encoding according to one or more embodiments. Referring to FIG. 10, according to one or more embodiments, an electronic device may transmit (or output) an image frame including a bypass flag through operations 1010 to 1080 described below.

In operation 1010, the electronic device may receive input image data including an input image block.

In operation 1020, the electronic device may divide the input image block received in operation 1010 into sub-blocks.

In operation 1030, the electronic device may generate first sub-latent vectors respectively corresponding to the sub-blocks by inputting the sub-blocks obtained in operation 1020 to a neural network (e.g., an encoder neural network) and encoding the sub-blocks. The electronic device may generate the first sub-latent vectors respectively corresponding to the sub-blocks by inputting the sub-blocks to the neural network in parallel and encoding them accordingly.

In operation 1040, the electronic device may generate second sub-latent vectors with respective ranges of the first sub-latent vectors generated in operation 1030 adjusted based on a preset target compression ratio.

In operation 1050, the electronic device may determine a 1-2 compression ratio of each of the second sub-latent vectors generated in operation 1040.

In operation 1060, the electronic device may adaptively determine whether to perform entropy coding on each of the second sub-latent vectors based on whether the 1-2 compression ratio of each of the second sub-latent vectors determined in operation 1050 satisfies the target compression ratio. The 1-2 compression ratio may correspond to a compression ratio of each of the first sub-latent vectors. For example, when the 1-2 compression ratio of the second sub-latent vectors is greater than or equal to the target compression ratio, the electronic device may bypass the entropy coding for the second sub-latent vectors. Alternatively, when the 1-2 compression ratio of the second sub-latent vectors is less than the target compression ratio, the electronic device may perform the entropy coding on the second sub-latent vectors.

In operation 1070, the electronic device may set a value of a bypass flag corresponding to each of the second sub-latent vectors based on whether to perform the entropy coding determined in operation 1060. For example, in response to bypassing the entropy coding for the second sub-latent vector, the electronic device may set the bypass flag to a first value (e.g., “1”). Alternatively, in response to performing the entropy coding on the second sub-latent vector, the electronic device may set the bypass flag to a second value (e.g., “0”) that is different from the first value.

In operation 1080, the electronic device may transmit an image frame including the bypass flag set in operation 1070.

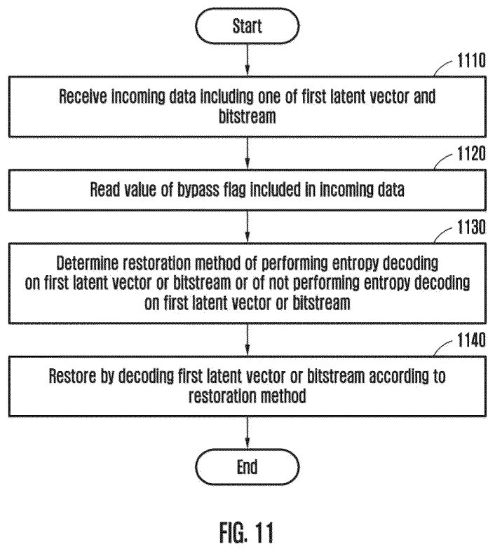

FIG. 11 is a flowchart illustrating an image processing method of an electronic device performing decoding according to one or more embodiments. Referring to FIG. 11, according to one or more embodiments, an electronic device may include a neural network and restore incoming data through operations 1110 to 1130 described below.

In operation 1110, the electronic device may receive incoming data including one of a first latent vector or a bitstream. In this case, the first latent vector may be a latent vector with a range of an initial latent vector corresponding to input image data adjusted based on a preset target compression ratio. The bitstream may be generated through entropy encoding performed on the first latent vector.

In operation 1120, the electronic device may read a value of a bypass flag included in the incoming data received in operation 1110. The value of the bypass flag included in the incoming data may be “0” or “1,” for example.

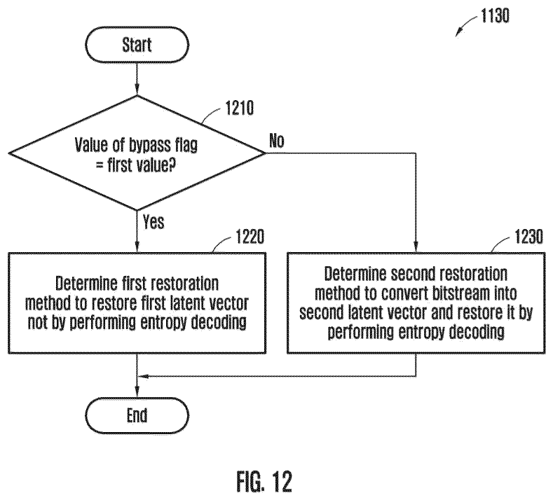

In operation 1130, the electronic device may determine a restoration method for the first latent vector or the bitstream, based on the value of the bypass flag read in operation 1120. In this case, the restoration method may be one of a method of performing entropy decoding or a method not performing the entropy decoding. For example, in response to the value of the bypass flag being a first value (e.g., “1”), this value may indicate that the first latent vector is included without the received incoming data having been through entropy coding (or with the received incoming data bypassing the entropy coding). In response to the value of the bypass flag being “1,” the received incoming data (e.g., the first latent vector) may be restored by a decoder neural network, without the entropy decoding performed by an entropy decoder. Alternatively, in response to the value of the bypass flag being a second value (e.g., “0”), this value may indicate the bitstream generated with the received incoming data having been through the entropy coding. In response to the value of the bypass flag being “0,” the received incoming data (e.g., the bitstream) may be restored by the entropy decoding and the decoding. A method by which the electronic device determines the restoration method of restoring incoming data will be described in more detail below with reference to FIG. 12.

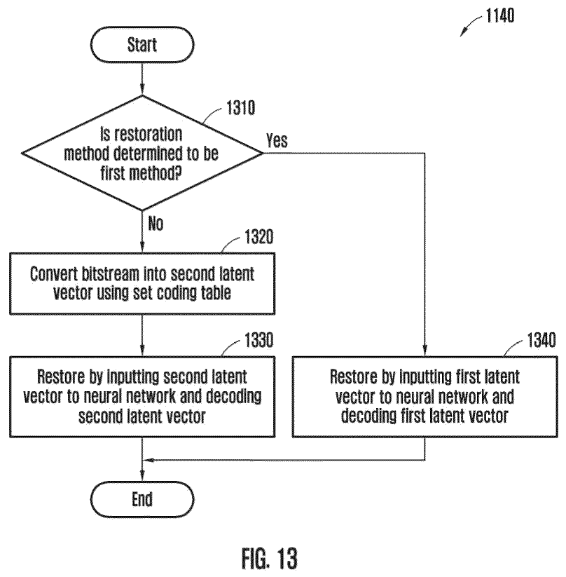

In operation 1140, the electronic device may restore the received incoming data, i.e., the first latent vector or the bitstream, by decoding according to the restoration method determined in operation 1130. The electronic device may restore the data by decoding the first latent vector or the bitstream using the neural network. A method by which the electronic device restores incoming data will be described in more detail below with reference to FIG. 13.

FIG. 12 is a flowchart illustrating a method performed by an electronic device performing decoding to determine a restoration method for incoming data according to one or more embodiments. Referring to FIG. 12, according to one or more embodiments, an electronic device may include a neural network (e.g., an encoder neural network) and may determine a restoration method of restoring incoming data through operations 1210 to 1230 described below.

In operation 1210, the electronic device may determine whether a value of a bypass flag is equal to a first value (e.g., “1”). In operation 1220, in response to the value of the bypass flag being determined to be equal to the first value (e.g., “1”) in operation 1210, the electronic device may determine the restoration method to be a first restoration method that restores a first latent vector without performing entropy decoding. The first restoration method may restore incoming data (e.g., the first latent vector) by performing a decoding process without performing the entropy decoding.

In operation 1230, in response to the value of the bypass flag being determined not to be equal to the first value (e.g., “1”) in operation 1210, that is, when the value of the bypass flag is determined to be a second value (e.g., “0”), the electronic device may determine the restoration method to be a second restoration method that converts a bitstream into a second latent vector by the entropy decoding to restore the bitstream. The second restoration method may restore the incoming data (e.g., the bitstream) by performing the entropy decoding and performing the decoding process.

FIG. 13 is a flowchart illustrating a method of restoring incoming data based on a determined restoration method according to one or more embodiments. Referring to FIG. 13, according to one or more embodiments, an electronic device performing decoding may restore incoming data through operations 1310 to 1340 described below.

In operation 1310, the electronic device may determine whether a restoration method is determined to be a first method.

In operation 1340, in response to the restoration method being determined to be the first method in operation 1310, the electronic device may restore the incoming data by inputting the first latent vector to a neural network and decoding it.

In operation 1320, in response to the restoration method being determined not to be the first method in operation 1310 (i.e., when the restoration method is determined to be a second method), the electronic device may convert a bitstream into a second latent vector using a set coding table. In operation 1330, the electronic device may restore the incoming data by inputting the second latent vector obtained through the conversion in operation 1320 to the neural network and decoding it. In this case, the neural network may correspond to a neural decoder or a decoder network.

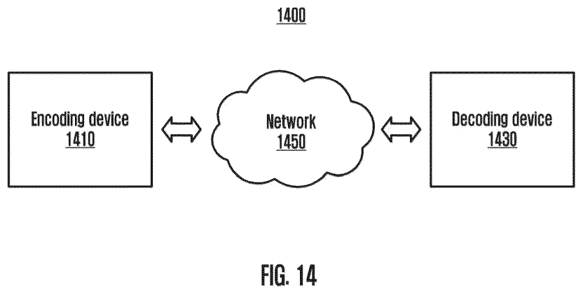

FIG. 14 is a diagram illustrating an image processing system according to one or more embodiments. Referring to FIG. 14, according to one or more embodiments, an image processing system 1400 may include an electronic device (or an “encoding device” 1410) configured to perform encoding, an electronic device (or a “decoding device” 1430) configured to perform decoding, and a network 1450. The encoding device 1410 and/or the decoding device 1430 may correspond to an electronic device including an encoding module (e.g., the encoding module 112 of FIG. 1, the encoding module 205 of FIG. 2, the encoding module 305 of FIG. 3, the encoding module 405 of FIG. 4, and/or the encoding module 505 of FIG. 5) and a decoding module (e.g., the decoding module 114 of FIG. 1, the decoding module 207 of FIG. 2, the decoding module 307 of FIG. 3, the decoding module 407 of FIG. 4, and/or the decoding module 505 of FIG. 5), respectively, as described above.

The encoding device 1410 may process (e.g., encode) image data such as a video including a plurality of image frames, a single image, or a moving image (or video), and transmit a result of the processing to an external device. For example, the encoding device 1410 may be an electronic device including, but not necessarily limited to, a content providing device configured to provide image content, an image broadcasting device, or a terminal configured to transmit images for a video call or video conference. The encoding device 1410 may generate encoded data with a data size reduced by encoding (or compressing) entirety or at least a portion of the image data, to reduce the amount of transmission of the image data and increase the speed of transmission of the image data.

The encoding device 1410 may include, but is not necessarily limited to, a neural encoder configured to perform an encoding process that compresses input image data and generate a latent vector and/or a bitstream.

The image data (e.g., the compressed image data) processed by the encoding device 1410 may be transmitted (or transferred) to the decoding device 1430 over the network 1450. According to one or more embodiments, the image data transmitted from the encoding device 1410 to the decoding device 1430 may be, but is not necessarily limited to, feature information (e.g., feature maps, latent vectors, and/or bitstreams) of the original image data extracted through an encoding process.

The network 1450 may include a wired network of a cable network, a short-range wireless network, or a long-range wireless network. The short-range wireless network may include, for example, Bluetooth, wireless fidelity (Wi-Fi), or infrared data association (IrDA). The long-range wireless network may include, for example, a legacy cellular network, a 3G/4G/5G network, a next-generation communication network, the Internet, and/or a computer network (e.g., a local area network (LAN) or a wide area network (WAN)).

The decoding device 1430 may receive encoded image data (or encoded feature information) generated by the encoding device 1410 over the network 1450. In one or more embodiments, the encoded image data generated by the encoding device 1410 may be transmitted directly to the decoding device 1430 over the network 1450 or may be transmitted to the decoding device 1430 via one or more other devices. The decoding device 1430 may be an electronic device of various types. The decoding device 1430 may include, as non-limiting examples, a portable communication device (e.g., a smartphone), a computer device, a portable multimedia device (e.g., a tablet PC), a camera, a wearable device, a set-top box, an image (video) streaming device, a content storage device, or a consumer electronics device (e.g., TV). However, embodiments are not limited thereto.

The decoding device 1430 may process the encoded image data and provide the processed image data to a user. For example, the decoding device 1430 may decode the encoded image data and provide image data restored by the decoding to the user. The encoding performed by the encoding device 1410 may reduce the data size of the original image data, which may result in a loss of some information included in the original image data during the encoding process. The decoding device 1430 may restore the information lost during the encoding process for encoding the image data through decoding, thereby generating the image data of higher image quality than the encoded image data.

The decoding device 1430 may include, but is not necessarily limited to, a neural decoder based on a neural network that performs a decoding process of restoring (or decompressing) the encoded (or compressed) image data to restore a feature that is lost in the encoding process. The neural network may refer to a model in which artificial neurons (or nodes) formed into a network by synaptic coupling have a problem-solving capability by changing the strength of the synaptic coupling through training or machine learning. An artificial neuron in the neural network may include a combination of weights and/or biases, and the neural network may include one or more layers including a plurality of artificial neurons.

The image processing system 1400 may be implemented in a PC, a cloud server, a data server, or a portable device. The portable device may be implemented as, for example, a laptop computer, a mobile phone, a smartphone, a tablet PC, a mobile Internet device (MID), a personal digital assistant (PDA), an enterprise digital assistant (EDA), a digital still camera, or a digital video camera, digital video camera, a portable multimedia player (PMP), a personal or portable navigation device (PND), a handheld game console, an e-book, and/or a smart device. The smart device may be implemented as, for example, a smartwatch, a smart band, smart glasses, and/or a smart ring.

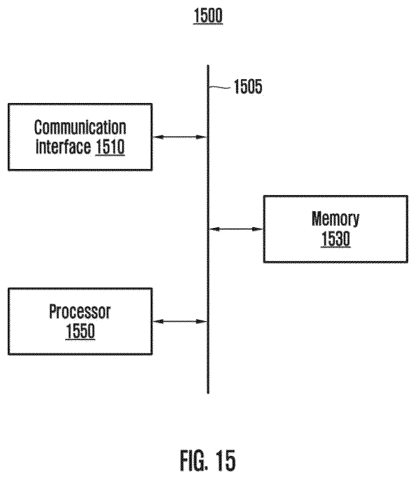

FIG. 15 is a block diagram illustrating an electronic device performing encoding according to one or more embodiments. Referring to FIG. 15, according to one or more embodiments, an electronic device 1500 may perform image processing using a neural network (e.g., an encoder neural network) and include a communication interface 1510, a memory 1530, and a processor 1550. The communication interface 1510, the memory 1530, and the processor 1550 may be connected to each other via a communication bus 1505. The communication interface 1510, the memory 1530, the processor 1550, and the communication bus 1505 may be included in a SoC. Some of the components may be omitted from, or some other components may be added to, the electronic device 1500.

The communication interface 1510 may receive input image data. The input image data may be, for example, a 2D image frame. Alternatively, the input image data may be an input image block or a plurality of sub-blocks. The electronic device 1500 may divide the input image data including an input image block into sub-blocks.

The communication interface 1510 may transmit a latent vector generated by the processor 1550.

The memory 1530 may store the neural network. The neural network may be, for example, but is not necessarily limited to, an entropy coder performing entropy coding and/or a neural encoder performing encoding to compress image data. The neural encoder may operate to be compatible with a standard video codec. A bitstream generated by the neural encoder may be interpreted by a decoder of the standard video codec or may be restored to an image by any video decoder that complies with the same standards. The neural encoder may train the neural network such that an output corresponding to each of a plurality of input frames is to be processed by the standard decoder. The standard decoder may include, for example, but is not necessarily limited to, high-efficiency video coding (HEVC). The neural encoder may train the neural network through, for example, unsupervised learning or self-supervised learning. The neural network may include a DNN. The neural network may also include, for example, a CNN, a recurrent neural network (RNN), a perceptron, a multilayer perceptron, a feedforward (FF) network, a radial basis function (RBF) network, a deep feedforward (DFF) network, a long short-term memory (LSTM), a gated recurrent unit (GRU), an autoencoder (AE), a variational autoencoder (VAE), a denoising autoencoder (DAE), a sparse autoencoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DC-IGN), a generative adversarial network (GAN), a liquid state machine (LSM), an extreme learning machine (ELM), an echo state network (ESN), a deep residual network (DRN), a differentiable neural computer (DNC), a neural Turing machine (NTM), a capsule network (CN), a Kohonen network (KN), a binarized neural network (BNN), a transformer, or an attention network (AN). The neural network may refer to a model in which artificial neurons (or nodes) formed into a network by synaptic coupling have a problem-solving capability by changing the strength of the synaptic coupling through training or machine learning. An artificial neuron in the neural network may include a combination of weights and/or biases, and the neural network may include one or more layers including a plurality of artificial neurons. The neural encoder may perform unsupervised learning using, for example, rate-distortion (RD) loss.

The memory 1530 may also store instructions (or programs) executable by the processor 1550. The instructions may include, for example, instructions for executing operations of the processor 1550 and/or instructions for executing operations of each component of the processor 1550.

The memory 1530 may be implemented as a volatile memory device or a non-volatile memory device. The volatile memory device may be implemented as, for example, a DRAM, a static RAM (SRAM), a thyristor RAM (T-RAM), a zero capacitor RAM (Z-RAM), or a twin transistor RAM (TTRAM). The non-volatile memory device may be implemented as, for example, an electrically erasable programmable read-only memory (EEPROM), a flash memory, a magnetic RAM (MRAM), a spin-transfer torque MRAM (STT-MRAM), a conductive bridging RAM (CBRAM), a ferroelectric RAM (FeRAM), a phase-change RAM (PRAM), a resistive RAM (RRAM), a nanotube RRAM, a polymer RAM (PoRAM), a nano-floating gate memory (NFGM), a holographic memory, a molecular electronic memory device, or an insulator resistance change memory.

The processor 1550 may generate a first latent vector corresponding to the input image data by inputting the input image data received via the communication interface 1510 to the neural network and encoding the input image data. The processor 1550 may generate a second latent vector that is quantized by adjusting a range of the first latent vector based on a preset target compression ratio.

The processor 1550 may also perform at least one of the methods or an algorithm corresponding to the at least one method, described above with reference to FIGS. 1 through 14. The processor 1550 may be a hardware-implemented data processing device with physically structured circuitry for executing desired operations. The desired operations may include, for example, code or instructions included in a program. The processor 1550 may be configured as, for example, a CPU, a GPU, or NPU. The processor 1550 may include, for example, a microprocessor, a CPU, a processor core, a multi-core processor, a multiprocessor, an ASIC, or a FPGA.

The processor 1550 may execute the program and control the electronic device 1500. The program code executed by the processor 1550 may be stored in the memory 1530.

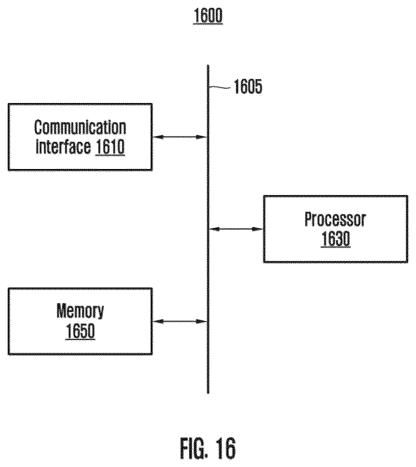

FIG. 16 is a block diagram illustrating an electronic device performing decoding according to one or more embodiments. Referring to FIG. 16, according to one or more embodiments, an electronic device 1600 may perform image processing using a neural network (e.g., a decoder neural network) and include a communication interface 1610, a processor 1630, and a memory 1650. The communication interface 1610, the processor 1630, and the memory 1650 may be connected to each other via a communication bus 1605. The communication interface 1610, the processor 1630, the memory 1650, and the communication bus 1605 may be included in a SoC. Some of the components may be omitted from, or some other components may be added to, the electronic device 1600.

The communication interface 1610 may receive incoming data including one of a second latent vector with a range of a first latent vector corresponding to the input image data adjusted based on a preset target compression ratio or a bitstream generated through entropy encoding for the second latent vector. The received incoming data may be, for example, in the form of the second latent vector that is to be restored without entropy decoding or in the form of the bitstream that is to be restored by the entropy decoding. Alternatively, the received incoming data may be a first sub-latent vector or sub-blocks.

The processor 1630 may read a value of a bypass flag included in the incoming data received via the communication interface 1610. Based on the value of the bypass flag, the processor 1630 may determine a restoration method for the incoming data, i.e., the second latent vector or the bitstream. The processor 1630 may restore the incoming data by decoding the second latent vector or the bitstream, using the neural network, according to the determined restoration method.

The processor 1630 may also perform at least one of the methods or an algorithm corresponding to the at least one method, described above with reference to FIGS. 1 through 15. The processor 1630 may be a hardware-implemented data processing device with physically structured circuitry for executing desired operations. The desired operations may include, for example, code or instructions included in a program. The processor 1630 may be configured as, for example, a CPU, a GPU, or an NPU. The processor 1630 may include, for example, a microprocessor, a CPU, a processor core, a multi-core processor, a multiprocessor, an ASIC, or an FPGA.

The processor 1630 may execute the program and control the electronic device 1600. The program code executed by the processor 1630 may be stored in the memory 1650.

The memory 1650 may store the neural network. The neural network may be, for example, but is not necessarily limited to, an entropy decoder performing the entropy decoding and/or a neural decoder performing decompression or restoration on compressed image data. The neural decoder may train the neural network through, for example, unsupervised learning or self-supervised learning. The neural network may include a DNN. The neural network may also include, for example, a CNN, a RNN, a perceptron, a multilayer perceptron, a FF network, a RBF network, a DFF network, a LSTM, a GRU, an AE, a VAE, a DAE, a SAE, a MC, a HN, a BM, a RBM, a DBN, a DCN, a DN, a DC-IGN, a GAN, a LSM, an ELM, an ESN, a DRN, a DNC, a NTM, a CN, a KN, a BNN, a transformer, or an AN. The neural network may refer to a model in which artificial neurons (or nodes) formed into a network by synaptic coupling have a problem-solving capability by changing the strength of the synaptic coupling through training or machine learning. An artificial neuron in the neural network may include a combination of weights and/or biases, and the neural network may include one or more layers including a plurality of artificial neurons.

The memory 1650 may also store instructions (or programs) executable by the processor 1630. The instructions may include, for example, instructions for executing operations of the processor 1630 and/or instructions for executing operations of each component of the processor 1630.

The memory 1650 may be implemented as a volatile memory device or a non-volatile memory device. The volatile memory device may be implemented as, for example, a DRAM, a SRAM, a T-RAM, a Z-RAM, or a TTRAM. The non-volatile memory device may be implemented as, for example, an EEPROM, a flash memory, a MRAM, a STT-MRAM, a CBRAM, a FeRAM, a PRAM, a RRAM, a nanotube RRAM, a PoRAM, a NFGM, a holographic memory, a molecular electronic memory device, or an insulator resistance change memory.

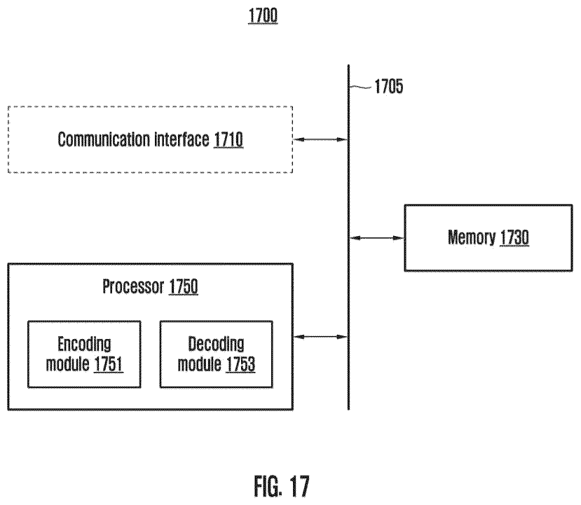

FIG. 17 is a block diagram illustrating an electronic device performing encoding and decoding according to one or more embodiments. Referring to FIG. 17, according to one or more embodiments, an electronic device 1700 may perform image processing including encoding and decoding, using a neural network (e.g., an encoder neural network and a decoder neural network), and include a memory 1730 and a processor 1750. According to one or more embodiments, the electronic device 1700 may further include a communication interface 1710.

The communication interface 1710, the memory 1730, and the processor 1750 may be connected to each other via a communication bus 1705. The communication interface 1710, the memory 1730, the processor 1750, and the communication bus 1705 may be included in a SoC. Some of the components may be omitted from, or some other components may be added to, the electronic device 1700.

The communication interface 1710 may receive input image data or incoming data.

The memory 1730 may store the neural network. The neural network may be, for example, but is not necessarily limited to, an entropy decoder performing entropy decoding and/or a neural decoder performing decompression or restoration on compressed image data. The neural decoder may train the neural network through, for example, unsupervised learning or self-supervised learning. The neural network may include a DNN. The neural network may also include, for example, a CNN, a RNN, a perceptron, a multilayer perceptron, a FF network, a RBF network, a DFF network, a LSTM, a GRU, an AE, a VAE, a DAE, a SAE, a MC, a HN, a BM, a RBM, a DBN, a DCN, a DN, a DC-IGN, a GAN, a LSM, an ELM, an ESN, a DRN, a DNC, a NTM, a CN, a KN, a BNN, a transformer, or an AN. The neural network may refer to a model in which artificial neurons (or nodes) formed into a network by synaptic coupling have a problem-solving capability by changing the strength of the synaptic coupling through training or machine learning. An artificial neuron in the neural network may include a combination of weights and/or biases, and the neural network may include one or more layers including a plurality of artificial neurons.

The memory 1730 may also store instructions (or programs) executable by the processor 1750. The instructions may include, for example, instructions for executing operations of the processor 1750 and/or instructions for executing operations of each component of the processor 1750.

The memory 1730 may be implemented as a volatile memory device or a non-volatile memory device. The volatile memory device may be implemented as, for example, a DRAM, a SRAM, a T-RAM, a Z-RAM, or TTRAM. The non-volatile memory device may be implemented as, for example, an EEPROM, a flash memory, a MRAM, a STT-MRAM, a CBRAM, a FeRAM, a PRAM, a RRAM, a nanotube RRAM, a PoRAM, a NFGM, a holographic memory, a molecular electronic memory device, or an insulator resistance change memory.

The processor 1750 may include an encoding module 1751 and a decoding module 1753. The encoding module 1751 may generate a first latent vector corresponding to input image data by inputting the input image data to the neural network and encoding the input image data. The encoding module 1751 may generate a second latent vector that is quantized by adjusting a range of the first latent vector based on a preset target compression ratio or generate a bitstream obtained through entropy encoding performed on the second latent vector.

The decoding module 1753 may read a value of a bypass flag included in incoming data including any one of the second latent vector or the bitstream. The decoding module 1753 may restore the incoming data by decoding the incoming data using the neural network according to a restoration method for the incoming data determined based on the value of the bypass flag.

The processor 1750 may also perform at least one of the methods or an algorithm corresponding to the at least one method, described above with reference to FIGS. 1 through 16. The processor 1750 may be a hardware-implemented data processing device with physically structured circuitry for executing desired operations. The desired operations may include, for example, code or instructions included in a program. The processor 1750 may be configured as, for example, a CPU, a GPU, or an NPU. The processor 1750 may include, for example, a microprocessor, a CPU, a processor core, a multi-core processor, a multiprocessor, an ASIC, or an FPGA.

The processor 1750 may execute the program and control the electronic device 1700. The program code executed by the processor 1750 may be stored in the memory 1730.

The example embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art may appreciate that a processing device may include multiple processing elements and multiple types of processing elements. For example, a processing device may include multiple processors or a processor and a controller. In addition, different processing configurations may be possible, such as, parallel processors.

The software may include a computer program, a piece of code, an instruction, or some combination thereof, to independently or collectively instruct and/or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded in the media may be specially designed and constructed for the purposes of examples, or they may be of the kind well-known and available to one or ordinary skill in the computer software arts. Examples of non-transitory computer-readable media include magnetic media such as hard disks, floppy disks, and magnetic tape; optical media such as compact disc (CD) read-only memory (ROM) (CD-ROM) discs, digital versatile discs (DVDs), and/or Blue-ray discs; magneto-optical media such as optical discs; and hardware devices that are specially configured to store and perform program instructions, such as ROM, RAM, flash memory (e.g., universal serial bus (USB) flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An image processing method using a neural network, comprising:
receiving input image data;
generating a first latent vector corresponding to the input image data by inputting the input image data to the neural network and encoding the input image data; and
generating a second latent vector based on the first latent vector,
wherein a range of the first latent vector is adjusted based on a preset target compression ratio.

2. The image processing method of claim 1, wherein the generating of the second latent vector further comprises:
clipping the range of the first latent vector to a range corresponding to the preset target compression ratio.

3. The image processing method of claim 2, wherein the generating of the second latent vector comprises:
quantizing the clipped first latent vector.

4. The image processing method of claim 1, further comprising:
determining a first compression ratio corresponding to the second latent vector; and
adaptively determining whether to perform entropy coding on the second latent vector, based the first compression ratio.

5. The image processing method of claim 4, wherein the adaptively determining whether to perform the entropy coding comprises:
based on the first compression ratio of the second latent vector being greater than or equal to the preset target compression ratio, determining to bypass the entropy coding for the second latent vector; and
based on the first compression ratio of the second latent vector being less than the preset target compression ratio, determining to perform the entropy coding on the second latent vector.

6. The image processing method of claim 4, wherein the adaptively determining whether to perform the entropy coding comprises:
setting a value of a bypass flag corresponding to the second latent vector.

7. The image processing method of claim 6, wherein the setting of the value of the bypass flag comprises:
based on determining to bypass the entropy coding for the second latent vector, setting the value of the bypass flag to a first value; and
based on determining to perform the entropy coding on the second latent vector, setting the value of the bypass flag to a second value that is different from the first value.

8. The image processing method of claim 1, further comprising:
generating a bitstream by performing entropy coding on the second latent vector;
comparing a second compression ratio of the second latent vector that is entropy-coded to a third compression ratio; and
outputting either the bitstream or the second latent vector, based on a result of the comparison.

9. The image processing method of claim 8, further comprising learning a coding table corresponding to an entropy coder based on the range of the second latent vector that is adjusted based on the preset target compression ratio.

10. The image processing method of claim 8, wherein the outputting of either the bitstream or the second latent vector based on the result of the comparing comprises:
based on the second compression ratio being greater than or equal to the third compression ratio, outputting the bitstream; and
based on the second compression ratio being less than the third compression ratio, outputting the second latent vector.

11. The image processing method of claim 1, wherein the input image data comprises an input image block, and
wherein the image processing method further comprises dividing the input image block into sub-blocks.

12. The image processing method of claim 11, wherein the generating of the first latent vector further comprises:
generating first sub-latent vectors respectively corresponding to the sub-blocks by encoding the sub-blocks,
wherein the generating of the second latent vector comprises generating second sub-latent vectors based on the first sub-latent vectors, and
wherein respective ranges of the first sub-latent vectors are adjusted based on the preset target compression ratio.

13. The image processing method of claim 12, wherein the generating of the first sub-latent vectors comprises inputting the sub-blocks to the neural network in parallel and encoding the sub-blocks.

14. The image processing method of claim 12, further comprising:
determining whether to perform entropy coding on each of the second sub-latent vectors.

15. The image processing method of claim 14, wherein the determining whether to perform the entropy coding on each of the second sub-latent vectors comprises:
determining a 1-2 compression ratio of each of the second sub-latent vectors; and
adaptively determining whether to perform the entropy coding on each of the second sub-latent vectors, based on whether the 1-2 compression ratio of each of the second sub-latent vectors satisfies the preset target compression ratio.

16. An image processing method using a neural network, comprising:
receiving incoming data comprising a first latent vector or a bitstream, the incoming data comprising a bypass flag;
reading a value of the bypass flag;
determining a restoration method for the first latent vector or the bitstream, based on the value of the bypass flag; and
restoring the incoming data by decoding the first latent vector or the bitstream based on the determined restoration method.

17. The image processing method of claim 16, wherein the determining of the restoration method comprises:
based on the value of the bypass flag being a first value, determining the restoration method to be a first restoration method that restores the first latent vector without performing entropy decoding; and
based on the value of the bypass flag being a second value, determining the restoration method to be a second restoration method that converts the bitstream into a second latent vector by performing entropy decoding.

18. The image processing method of claim 17, wherein the restoring of the incoming data based on the determined restoration method comprises:
based on the restoration method being determined to be the first restoration method, restoring the incoming data by inputting the first latent vector to the neural network and decoding the first latent vector.

19. The image processing method of claim 17, wherein the restoring of the incoming data based on the determined restoration method comprises, based on the restoration method being determined to be the second restoration method:
converting the bitstream into the second latent vector using a set coding table; and
restoring the incoming data by inputting the second latent vector to the neural network and decoding the second latent vector.

20. An electronic device configured to perform image processing using a neural network, the electronic device comprising:
memory storing instructions; and
a processor,
wherein the instructions, when executed by the processor, cause the electronic device to:
generate a first latent vector corresponding to input image data by inputting the input image data to the neural network and encoding the input image data;
generate a second latent vector that is quantized by adjusting a range of the first latent vector based on a preset target compression ratio;
receive incoming data comprising a bitstream or the second latent vector;
read a value of a bypass flag of the incoming data; and
restore, by the neural network, the incoming data by decoding the second latent vector or the bitstream based on a restoration method, and
wherein the restoration method is determined based on the value of the bypass flag.
